(19) United States
(12) Patent Application Publication
(10) Pub. No.: US 2013/0346849 A1
(43) Pub. Date: Dec. 26, 2013

(54) AUTOMATIC UPLOADING AND SYNCHRONIZATION OF MEDIA ASSETS

(71) Applicant: Minds + Machines, Santa Monica, CA (US)

(72) Inventor: Frederick R. Krueger, Santa Monica, CA (US)

(21) Appl. No.: 13/912,089

(22) Filed: Jun. 6, 2013

Related U.S. Application Data
(60) Provisional application No. 61/656,117, filed on Jun. 6, 2012.

(51) Int. Cl. G06F 17/22

(52) U.S. Cl. CPC G06F 17/2247
USPC 715/234

(57) ABSTRACT

A system and method for managing websites through two-way synchronization of the web site builder and a cloud file storage system.

### CROSS REFERENCE TO RELATED APPLICATIONS

This application claims priority to and all the benefits of U.S. Provisional Application No. 61/656,117 filed Jun. 6, 2012 and entitled “Method And System For Automatic Uploading And Synchronization Of Media Assets.”

### BACKGROUND OF THE INVENTION

1. Field of the Invention

The present invention relates to database management for websites.

2. Description of the Prior Art

The advantages of cloud storage are well known and well established. Cloud file storage (CFS applications, including, without limitation, DropBox, Box.Net, SkyDrive and Google Drive, have become highly popular as a means of backing up desktop files and making those files accessible on any device. A CFS system uses a desktop application to synchronize files and folders with the cloud. This enables a user to upload or delete one or more files by dragging and dropping the one or more files.

The advantages of hosted website-building tools such as, without limitation, WordPress.com, Weebly.com, and SquareSpace.com are also well established. Any one of such website-building tools is referred to herein as a “site builder”. Site-builder services can be accessed from a number of devices and site-builder services generally offer lower costs and higher reliability than non-hosted tools.

However, site builders have traditionally relied on users uploading data—either in individual data files or in batch mode—to the site builder application. As this data consists primarily of images, this process can be extremely time consuming for users. Each user typically keeps a local copy of this data on his or her machine and—increasingly—uses a CFS to back this data up. This creates duplicate non-synchronized data in the cloud: one copy on the site builder application and one copy on the CFS.

Because of this non-synchronization of data, any change of the image data on the website is not automatically reflected in the cloud storage. Furthermore, uploading to or deleting media assets from the website is time consuming—far more difficult than other operations involving general cloud storage, which is typically done with simple drag and drop.

Cloud storage systems now have multiple levels of backup, so that it is possible to revert to an earlier version of a media asset if a file is corrupted or for other reasons. A system and method for synchronizing one or more media assets with the CFS, so that the CFS is the site of record for storing the one or more media assets has eluded those skilled in the art until now.

### SUMMARY OF THE INVENTION

The present system and methods relate to the management of one or more media assets for a hosted website, online photo gallery, or online store. For ease of reference, any one of a hosted website, an online photo gallery, or an online store will be referred to herein as a “website.” However, it should be understood that the term “website” may refer to any one of a hosted website, an online photo gallery, an online store, or any set of resources that are available over a globally-accessible network, such as the Internet. In one embodiment of the system described herein, these media assets may be synchronized between two separate storage locations—the online storage of the website itself, and a cloud-based file-storage system such as, without limitation, DropBox, Box.Net or Google Drive. The term “CFS”, as used herein, refers to a cloud-based file-storage system.

The present inventive system and method are designed and configured to keep the media assets of the hosted website synchronized and backed up at the CFS. Furthermore, the present inventive system and method are designed and configured such that dragging and dropping a media asset file into the CFS may be sufficient to cause that media asset file to be displayed on the website, thus greatly facilitating the media asset uploading process.

The present inventive system and method is thus the first comprehensive solution to the data synchronization and uploading problem for websites.

In one embodiment of the present system and method, the website files are stored at both the web server and at the CFS, and a change in a file at either site triggers a synchronization of that file at the other site. Thus, the synchronization is two-way and allows the user to modify the website through either storage site: either through the web server or through the CFS.

In another embodiment of the system and method described herein, one or more media assets are stored at a website, the website being hosted by a site builder. The assets may be isolated from the presentation layer of the website and may be grouped in different folders referred to herein as “datasets”. The page code includes the page format or presentation element information but does not contain the actual variable content data to be presented, which is stored in the datasets. For example, a website may contain a page called “press releases” which pulls its data from a “press release dataset”. Another page called “items for sale” may pull its data from an “items dataset”. The association of the dataset with the website element that displays it may be defined in that element itself. For example, a “grid element” could either display press releases or items for sale, depending on which dataset was selected in the grid element's properties.

The data-types of a dataset may potentially vary from one dataset to another. For example, one dataset may contain video data, and another data set may contain only text fields. Alternatively, the data may be homogenous, with some fields remaining unused for certain data objects.

For each media asset in a dataset, the data comprising that media asset may be organized in one or more files. For example, within a product dataset, one file, for example, a dataset metafile, might describe the overall text fields of a product (title, description, etc.) and there may also be several image files describing the product images. The present inventive system and method may allow these files to be associated with the folder structure of general CFS products as described in detail below.

### BRIEF DESCRIPTION OF THE DRAWINGS

FIG. 1 an example implementation according to the present invention.

FIG. 2 illustrates an example implementation of datasets according to the present invention.

FIG. 3 is another example implementation of datasets on the cloud according to the present invention.

FIG. 4 shows an image inserted at the root of a dataset.

FIG. 5 illustrates an exemplary networking environment, wherein the novel aspects of the claimed subject matter can be employed.

FIG. 6 illustrates an exemplary operating environment that can be employed in accordance with the claimed subject matter.

### DETAILED DESCRIPTION

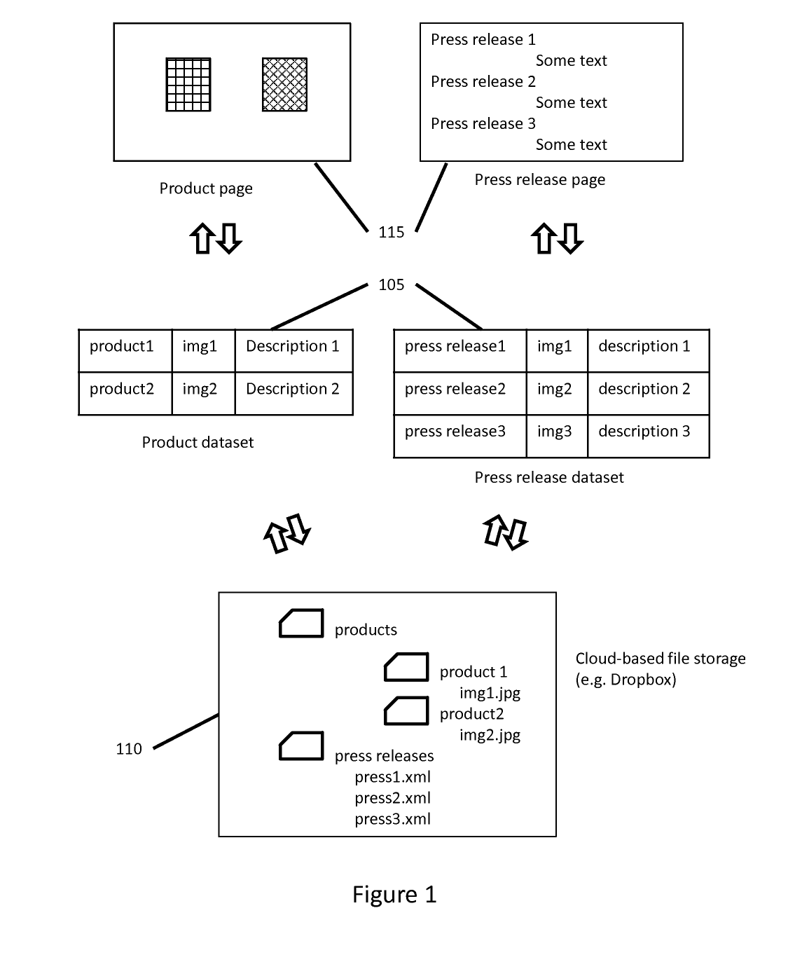

FIG. 1 illustrates one embodiment of the present inventive system and method. As illustrated in FIG. 1, the datasets and pages depicted in that figure are associated with a website, the website being hosted by a site builder, while the “cloud based file storage” is associated with a CFS. The website management system, generally shown as 100 in FIG. 1, includes at least one dataset 105 as part of a website builder. The datasets are in two-way synchronization with a CFS 110. The datasets 105 provide content for at least one webpage 115.

Datasets

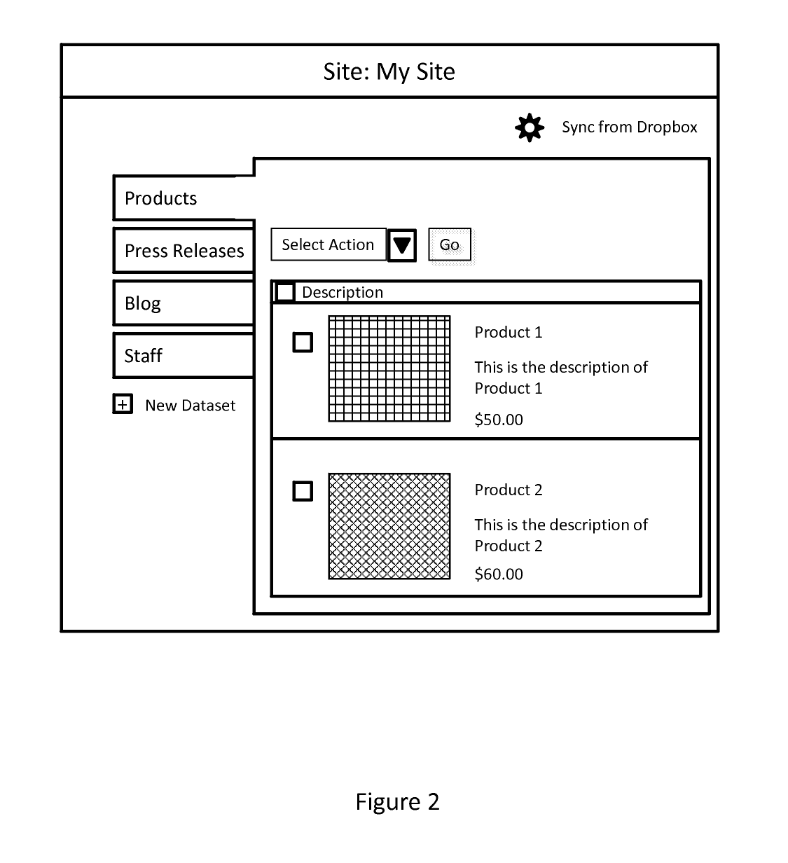

An example of one implementation of data sets on the site builder application is shown in FIG. 2.

In the illustrated embodiment, there are 4 datasets, Products, Press Releases, Blog and Staff. Each dataset contains data items that can be used by one or more website “widgets” to display the data on a page of a website.

Note the “Synchronize from DropBox” symbol in the upper right hand corner in FIG. 2. This feature may appear for a user who has not yet synchronized his or her website with a CFS such as Dropbox.

In the illustrated embodiment, when a user clicks on this symbol, an associated element may call Dropbox (or another CFS to which the user's website is linked) and the user may be asked for his or her cloud-based credentials (for example, user name and password). Once the user has been authenticated, then for each dataset of the user's website, the same file structure will be created on the user's cloud storage associated with the CFS. Thus, the present invention provides for the automatic creation of cloud storage of the data.

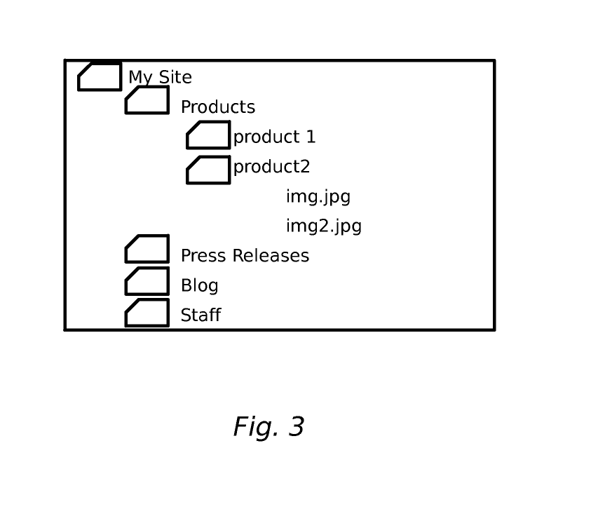

As illustrated in FIG. 3, each dataset may contain a number of folders. Each folder may be associated with an “item” in the relevant dataset—for example, an item associated with the “Products” dataset may be a product. An item associated with the “Press Releases” dataset may be a press release. An item associated with the “Blog” dataset may be a blog post. An item associated with the “Staff” dataset may be an employee. In an alternative embodiment, each particular item may correspond with a particular file in a particular folder.

In the illustrated embodiment, each folder may contain one or more media asset files, one for each media asset used to describe the item associated with the particular folder. In the above example, the Product data set contains 2 products, and the second product has 2 images—img.jpg and img2.jpg.

In the illustrated embodiment, the user can add a third image to the product2 folder simply by dragging the third image into the product2 folder in the CFS application.

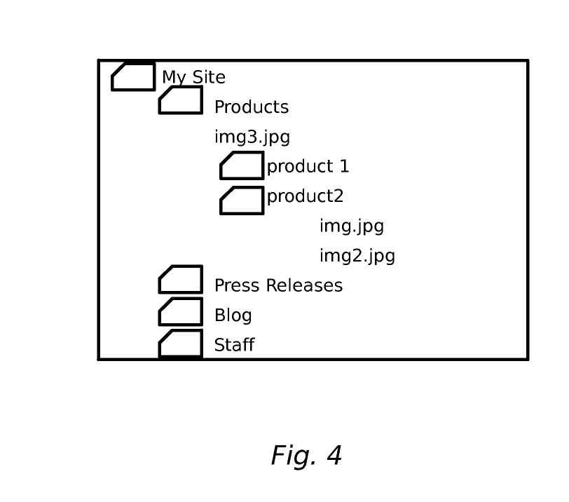

In another embodiment, one or more individual images, including still or video images, may be dragged into the root folder of any dataset. For example, as shown in FIG. 4, if image img3.png is dragged to the root folder of the “products” dataset, that image may be treated as a new, separate product. Thus, a newly-added file or folder in the root folder of a dataset is treated as an item, regardless of whether it is a file or a folder.

Furthermore, the present invention also provides for the automatic creation of files and folders on the site builder based on changes at the CFS. Thus, an item can be added to the CFS and this change will be reflected in the site builder.

Synchronization

In one embodiment of the present inventive system and method, the data associated with the website may be organized into datasets. Each dataset comprises a folder, each folder corresponding with a unique and identically named folder in the CFS. Inside any particular folder, there may be additional folders, each of which may be interpreted as an item inside the dataset. Inside each folder, there may be, in addition to or instead of the additional folders inside that folder, one or more individual files, each of which is interpreted as an individual item in the dataset. If a dataset folder contains files in addition to the files needed to define items, the additional files may be considered and interpreted as media asset files for a specific item.

In this embodiment, a number of events can happen that trigger synchronization between the site builder and the CFS including, but not limited to:
1. A file is added to the CFS
2. A file is deleted from the CFS
3. A folder is added to the CFS
4. A folder is deleted from the CFS
5. A media asset is added to the site builder
6. A media asset is deleted from the site builder
7. A new item is added to the site builder
8. An item is deleted from the site builder.

The present embodiment provides for two-way synchronization between the site builder and the CFS. In this two-way synchronization, adding a file or folder to either the site builder or the CFS will automatically synchronize the file or folder to the other storage site. The synchronization events are addressed below.

Adding a File to the CFS

One potential use of the present inventive system and method is to enable quick uploading of images and other media assets. In one embodiment of the system, dragging a file into the root folder of a dataset in the CFS may cause a new item to be created at the site builder, with the file being associated with the new item.

Since the data displayed on the website will correspond to one or more files in one or more datasets, dragging one or more such files onto the desktop CFS symbol may cause those files to be uploaded to the site builder and to be available for display on the website.

In one embodiment, if a file is dragged from (or into) an item folder—as opposed to the root folder of a dataset—it may be assumed that the file is a media asset of that existing item, and the file may be treated as such by the site builder. For example, if a second product image is dragged into a product folder, that second product image may be added to the product page on the website.

Deleting a File from the CFS

In one embodiment, deleting a file from the CFS, when the file is stored at the root level of a dataset, may delete the file from the site builder. Deleting a file from any of the item folders may cause that file to cease being associated with the item that is associated with the folder from which the file was deleted.

Adding a Folder to the CFS

In one embodiment, adding a new folder to the CFS may create a new default item in the dataset in the site builder. In one embodiment, the new item may start with no media assets.

Deleting a Folder from the CFS

In one embodiment, deleting a folder from the CFS may delete the associated items at the site builder and thus at the website. (Note that because the CFS usually stores backup information, this operation is typically recoverable.)

Adding a Media Asset File to the Site Builder

In one embodiment, adding a media asset file to the site builder adds the same media asset file to the associated item in the CFS.

Deleting a Media Asset File from the Site Builder

In one embodiment, deleting a media asset from the site builder deletes the same media asset file from the associated folder in the CFS.

Adding an Item to the Site Builder

In one embodiment, adding a new item to the site builder may create a new folder in the relevant dataset in the CFS. The folder may be empty unless the item is associated with one or more media asset files. If the item is a media asset, then the media asset is automatically transferred into the newly-created folder.

Deleting an Item from the Site Builder

In one embodiment, deleting an item from the site builder may delete the associated folder at the CFS. (Note that because the CFS usually stores backup information, this operation is typically recoverable.)

Replacing Existing Files

The present inventive system and method may also be used to replace existing files. A replacement can be viewed as a deletion followed by an addition, or can be implemented as a straight replacement. In either case, the CFS may be the repository of record—the standard against which the website at the site builder is synchronized.

The present invention thus makes management of multiple websites easier because a user can have folders on the CFS for the multiple websites and manage the websites through the CFS rather than having to log into multiple website domains to manage each website. Items can be quickly copied between website folders on the CFS. For example, an item that is offered for sale on multiple websites can be quickly updated on all the websites by changing the asset in the respective folders on the CFS.

A system according to the present invention comprises a website builder and a CFS, the website builder and the CFS in two-way synchronization. The system further provides for automatic creation of folders when an item is placed in the website root directory on the site builder.

A method according to the present invention comprises the following steps: providing a website builder component and a CFS component; the website builder component and the CFS component in two-way synchronization; making a change to a dataset on the website builder component or the CFS component; synchronizing the change to the unchanged component. The method further including the step of receiving a media file into the root directory of the website builder; automatically creating a new item folder; transferring the item into the new item folder; and synchronizing the new item folder to the CFS.

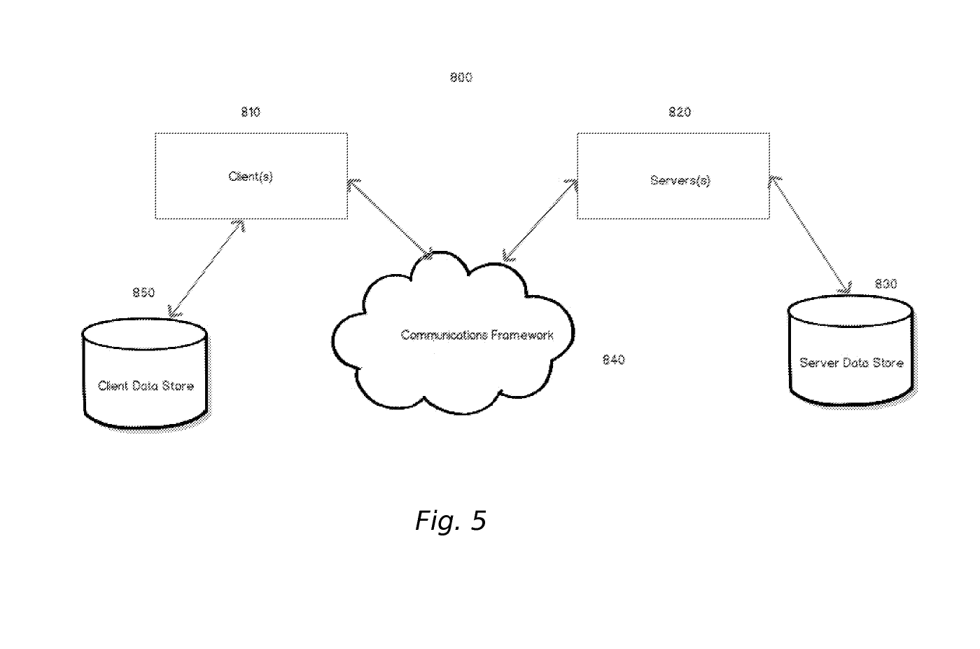

FIG. 5 is a schematic block diagram of a sample-computing environment 800 with which the claimed subject matter can interact. The system 800 includes one or more client(s) 810. The client(s) 810 can be hardware and/or software (e.g., threads, processes, computing devices). The system 800 also includes one or more server(s) 820. The server(s) 820 can be hardware and/or software (e.g., threads, processes, computing devices). The servers 820 can house threads to perform transformations by employing the subject innovation, for example.

One possible communication between a client 810 and a server 820 can be in the form of a data packet adapted to be transmitted between two or more computer processes. The system 800 includes a communication framework 840 that can be employed to facilitate communications between the client(s) 810 and the server(s) 820. The client(s) 810 are operably connected to one or more client data store(s) 850 that can be employed to store information local to the client(s) 810. Similarly, the server(s) 820 are operably connected to one or more server data store(s) 830 that can be employed to store information local to the servers 820.

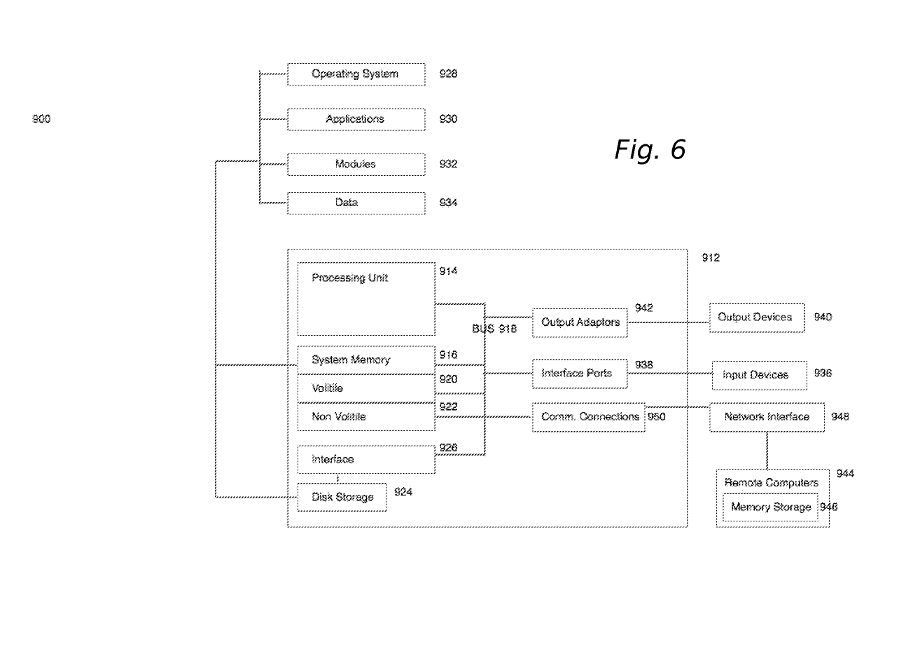

With reference to FIG. 6, an exemplary environment 900 for implementing various aspects of the claimed subject matter includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 916 includes volatile memory 920 and nonvolatile/non-transitory memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable programmable ROM (EEPROM), or flash memory. Volatile memory 920 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 912 also includes removable/non-removable, volatile/non-volatile computer storage media. FIG. 6 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 6 describes software that acts as an intermediary between users and the basic computer resources described in the suitable operating environment 900. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that the claimed subject matter can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940, which require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as modems, including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layer, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The Invention is:

1. A system for creating and editing websites, the system comprising:
a hosted website component including a first data storage in which is stored a plurality of data resources, the plurality of data resources being collectively associated with a website, the hosted website component making the plurality of data resources available as a website accessible over a global network; and
a cloud-based file storage (CFS) component including a second data storage, the CFS including a two-way synchronization element operative to keep data stored at the CFS synchronized with at least one remote location, the second data storage having stored therein a synchronized copy of the plurality of data resources;
wherein a change to a resource stored at either the CFS or at the hosted website results in the change being synchronized to the other of the CFS or the hosted website, and
further wherein the change to the resource at the CFS results in an automated change to the website accessible over the global network.

2. The system recited in claim 1, wherein the plurality of data resources comprises at least one media object.

3. The system recited in claim 2, wherein the media object is either a text file, an image file, a sound file, a video file, or some combination of them.

4. The system recited in claim 1, wherein the plurality of data resources comprises at least one dataset and further wherein the hosted website component is configured to serve a web page that includes a reference to the dataset, and still further wherein the dataset comprises at least one media object such that the reference to the dataset operates as an indirect association between the website and the media object.

5. The system recited in claim 4, wherein the hosted website is further configured to allow a selection of a type of item within a particular dataset, the type of item including at least one asset stored in association with the dataset.

6. A method for creating and editing websites, the method steps comprising:
establishing an association between a hosted website component and a cloud-based file storage (CFS) component, the association operative to enable two-way synchronization between resources stored at the hosted website component and the CFS component;
receiving a modification to a resource at either the hosted website component or the CFS component;
synchronizing the modification of the resource to an affiliated resource at the other of the hosted website component or the CFS component; and
serving a website at the hosted website component, the website automatically reflecting the modification made to the resource.

7. The method recited in claim 6, wherein the resource comprises a media object.

8. The method recited in claim 7, wherein the media object is either a text file, an image file, a sound file, a video file, or some combination of them.

9. The method recited in claim 6, wherein the resource comprises at least one dataset and further wherein the website includes a web page with a reference to the dataset, and still further wherein the dataset comprises at least one media object such that the reference to the dataset operates as an indirect association between the website and the media object.

10. The method recited in claim 9, further comprising receiving a selection of a type of item within a particular dataset, the type of item including at least one asset stored in association with the dataset.
